(19) United States
(12) Patent Application Publication
(10) Pub. No.: US 2002/0178108 A1
(43) Pub. Date: Nov. 28, 2002

(54) Fair and scalable trading system and method

(75) Inventors: Charles P. Tresser, New York, NY (US); Daniel C. Sturman, Englewood Cliffs, NJ (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 09/864,015

(22) Filed: May 23, 2001

(51) Int. Cl. G06F 17/60

(52) U.S. Cl. 705/37

(57) ABSTRACT

An electronic exchange implemented over a network that processes a series of call auctions, wherein each call auction occurs at an end of a trading interval, thus allowing customers at disparate network locations to participate in a fair manner. The system comprises: a plurality of network nodes that communicate market information, wherein the market information includes orders submitted from market participants; a plurality of gateway agents that timestamp orders after they are submitted by the market participants to the network; and a market maker system that receives and executes orders over the network, wherein the market maker system determines if each order qualifies for the call auction at the end of a current trading interval by examining the timestamp for the order.

### BACKGROUND OF THE INVENTION

1. Field of the Invention

The present invention relates generally to electronic market trading systems, and more particularly to a system and method for providing a fair and scalable trading environment over a network, such as the World Wide Web.

2. Related Art

Recent years have been marked by a very fast development of electronic trading. For example, the popularity of the World Wide Web (web) has prompted the development of on-line discount brokerages that provide trading services. Moreover, various market exchanges around the world are also beginning to offer on-line trading. All such companies (referred to herein as market makers) expect to reach massive numbers of customers all around the world. In some cases, they offer (or plan to offer) trading 24 hours a day, 7 days a week. With the more recent development of wireless access to the web, the number of people expected to trade on-line is expected to grow even more, so that successful exchanges or brokerage firms offering such services will be required to handle many millions of trades a day.

Ideally, in order for online trading to be fair, all people who trade need to have real time access to quotes and trade executions. Present day technology does not provide means to so largely distribute real time quotes, or receive execution instructions. Having unequal access time to quotes creates unfairness for those who have a bigger delay in the reception of the quote. This unfairness is even more severe for highly volatile markets, and one may expect that worldwide easy access to markets could often generate high volatility. Unfortunately, it is unlikely that technological progress will solve this problem since demand is expected to grow. Accordingly, a need exists for an online market system that can be scaled to a world wide marketplace while providing fair trading to all participants.

### SUMMARY OF THE INVENTION

The present invention overcomes the above-mentioned problems, as well as others by providing a market system and method that is at the same time fair to all participants, and also considerably more scalable than trading based on real time price adjustment. In a first aspect, the invention provides a system for implementing an electronic marketplace via a network, comprising: a market maker that receives orders for a series call auctions from a plurality of nodes in the network, wherein each of the orders includes a time stamp from one of a plurality of agents residing within the network, and wherein each call auction is implemented at an end of a trading interval; a trading system that sets prices and processes orders for each call auction; and a time analysis system that examines each order submitted during a current trading interval to determine if the submitted order qualifies for the call auction at the end of the current trading interval.

In a second aspect, the invention provides a program product stored on a recordable medium for implementing an electronic marketplace via a network, comprising: means for receiving orders for a series call auctions via a plurality of nodes in the network, wherein each of the orders includes a time stamp from one of a plurality of agents residing within the network, and wherein each call auction is implemented at an end of a trading interval; means for setting prices and processing orders at an execution time of each call auction; and means for examining timing information for each order submitted during a current trading interval to determine if the submitted order qualifies for the call auction at the end of the current trading interval.

In a third aspect, the invention provides an electronic exchange implemented over a network that processes a series of call auctions, each call auction occurring at an end of a trading intervals, comprising: a plurality of network nodes that communicate market information, wherein the market information includes orders submitted from market participants; a plurality of gateway agents that timestamp orders after they are submitted by the market participants to the network; and a market maker system that receives and executes orders over the network, wherein the market maker system determines if each order qualifies for the call auction at the end of a current trading interval by examining the timestamp for the order.

In a fourth aspect, the invention provides a method of implementing an electronic exchange over a network, wherein the exchange executes a series of call auctions during sequential trading intervals, comprising the steps of: broadcasting a price quote from a market maker over the network at a beginning of a current trading interval; distributing the price quote over a plurality of network nodes within the network; receiving an order submitted from a participant who is in communication with one of the network nodes;

time stamping the order when the order passes through a trusted node; delivering the order to the market maker; and examining the time stamp of the order to determine if the order qualifies for processing during the current trading interval.

In a fifth aspect, the invention provides a method for implementing an electronic exchange over a network, wherein the electronic exchange executes a series of auctions at sequential time points, comprising the steps of: broadcasting a price quote at a beginning of a trading interval; receiving an order, wherein the order includes a timestamp received from a network agent; comparing the timestamp with a first predetermined time set during the trading interval; comparing a time the order was received with a second predetermined time set during the current trading interval; and qualifying the order if both the timestamp is less than the first predetermined time and the time the order was received is less than the second predetermined time.

### BRIEF DESCRIPTION OF THE DRAWINGS

The preferred exemplary embodiment of the present invention will hereinafter be described in conjunction with the appended drawings, where like designations denote like elements, and:

FIG. 1 depicts an electronic exchange system implemented over a network in accordance with a preferred embodiment of the present invention.

FIG. 2 depicts a time line for a series of call auctions.

FIG. 3 depicts a time for a trading interval of a call auction in accordance with the present invention.

FIG. 4 depicts a flow chart depicting the processing of an order of the network of FIG. 1.

FIG. 5 depicts a flow chart of the timing analysis applied to an order received at the market maker of FIG. 1.

FIG. 6 depicts three exemplary cases involving the timing of received orders.

### DETAILED DESCRIPTION OF THE INVENTION

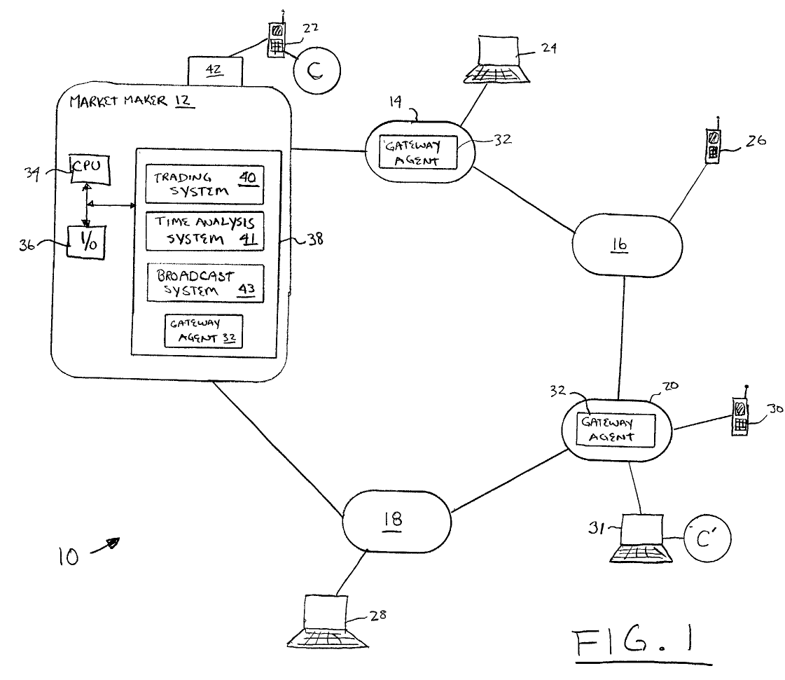

Referring first to FIG. 1, an exemplary electronic exchange or market system 10 is shown. System 10 comprises a market maker 12, a plurality of network nodes or routers 14, 16, 18 and 20, and a plurality of user interfaces 22, 24, 26, 28, 30, and 32. User interfaces may comprise, for example, personal computers, cell phones, hand held devices, personal digital assistants (PDA's), etc. As will be described, one of the goals of the present invention is to ensure fairness to all market participants, regardless of the time it takes to receive and transmit information over the network. While system 10 is preferably implemented on the web, it is understood that the present invention can be implemented on any type of network.

Market maker 12 may be implemented as a server that includes all of the processes and systems for implementing an electronic market or exchange. It should be understood that the market may comprise any type of trading, including securities, futures, goods, services, etc. Market maker 12 is preferably implemented on a computer system having a CPU 34, input/output (I/O) 36, and memory 38. Memory 38 may comprise any known type of data storage and/or transmission media, including magnetic media, optical media, random access memory (RAM), read-only memory (ROM), a data object, etc. Moreover, memory 38 may reside at a single physical location, comprising one or more types of data storage, or be distributed across a plurality of physical systems in various forms. CPU 34 may likewise comprise a single processing unit, or be distributed across one or more processing units in one or more locations, e.g., on a client and server. I/O 36 may comprise any known type of input output device, including, a network system, modem, keyboard, mouse, voice, CRT, printer, disk drives, etc. As an alternative embodiment, market maker 12 may be a collection of machines, distributed throughout the network rather than a centralized server.

Stored in memory 38 is a trading system 40 that handles the majority of the tasks involved with implementing an electronic market (e.g., implementing market rules and policies, setting pricing, administration, etc.). In this preferred embodiment, the market is implemented as a series of “call auctions,” the operation of which is described in further detail below. Time analysis system 41, which is also described in greater detail below, determines whether each order qualifies for processing and execution at a current or next call auction. Broadcast system 43 is responsible for broadcasting price quotes over the network in a manner that will ensure fairness to all participants.

As can be seen in FIG. 1, the path for an order from customer C at user interface 22 to the market maker 12 is considerably shorter than the path for customer C′ at user interface 31. The same is also true for quotes broadcast from market maker 12 to these two customers. In particular, customer C can communicate directly with market maker 12 via a wireless interface 22, while customer C′, who is trading from a personal computer, must communicate information across several nodes before reaching market maker 12.

To ensure fairness in establishing which orders qualify for a current auction, certain network nodes (e.g., nodes 14 and 20) include a gateway machine or agent system 32 that time stamps orders as they make their way to market maker 12. Gateway agent systems 32 preferably reside at trusted sites that can be relied on by market maker 12. Thus, each order is time stamped by an agent (i.e., gateway agent system 32) at some gateway to the network (or the wireless network), by secure machines trusted by market maker 12. In this case, the agents are located at node 20 for customer C′, and at wireless gateway 42 for customer C.

From the agent, orders are routed by the best available path, as determined, for example, by absolute availability and/or quality of service delivered by an Internet Service Provider (ISP) chosen by the customer to access market maker 12. Note that market maker 12 may also act as an ISP, and therefore may comprise a single or several ISPs available for a given equity proposed by market maker 12. For instance, if the preferred passage through node 16 is not available or too expensive, the route through node 18 would be chosen.

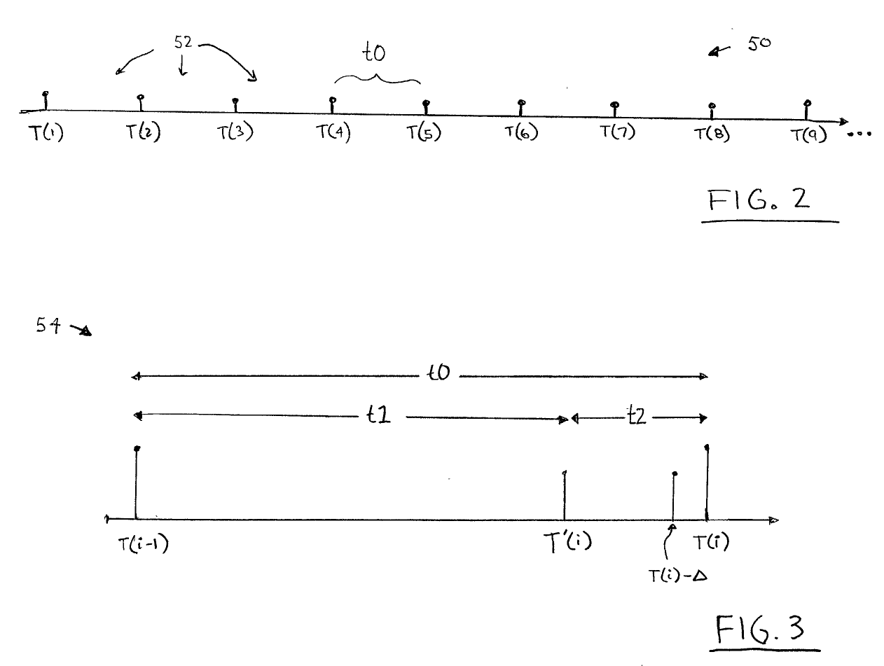

Referring to FIG. 2, a time line 50 depicting the timing of a series of call auctions according to the invention is shown. Time line 50 depicts a series a trading intervals 52, from T(1) to T(2), T(2) to T(3), T(3) to T(4), etc. Each trading interval 52 has a trading period to chosen by market maker 12. Thus, for a given security S0, the time of pricing and execution will occur at a sequence of discrete times, T(i), T(i+1) . . . . Accordingly, if the last pricing and trading occurred at T(i−1), the next pricing and trading will take place at:

T(i)=T(i−1)+t0.

At time T(i), a new price P(S0,T(i)) of the security S0 is fixed according to some well established (preferably by law) auction rule. For instance, the price may be chosen to maximize the money volume of transactions, or to maximize the number of orders that can be traded at that price at that time. Once the price P(S0, T(i)) is established, the new price at T(i) is broadcast (i.e., made public) and all orders compatible with P(S0, T(i)) that qualify (as determined by time analysis system 41) are executed.

Note that the trading period t0 can be fixed or variable. Because one of the roles of t0 is to allow all traders to get the same quote without relying on complex IT systems, market maker 12 can assess technology evolutions to determine if and when t0 should be reduced. For instance, for securities that are traded in a single country, the variations of trading delays may include weekends and holidays, or other non-trading periods such as the daily close of the market. Thus, t0 can be made variable to compensate for possible changes in the rate of transactions, in particular predictable changes such as those corresponding to daily rhythms or other calendar linked rhythms. Depending on choice, the series T(i), (Ti+1), . . . , can run indefinitely (24 hours a day, seven days a week) or can be reinitialized, e.g., every day or on some special set of circumstances.

At any time, or only after T(i−1) (depending on the rules imposed for the security S0 by the market maker), anyone trading on S0 can enter new orders to participate in the auction at time T(i). These can be a simple orders, limit orders, execute or cancel orders, or any of a variety of orders used on traditional markets. As a general rule, to participate in a security auction at T(n), a participant is required to submit the order sometime prior to T(n), as is explained below.

Referring now to FIG. 3, a second time line 54 is shown for the trading interval between T(i−1) and T(i). Because there is a time factor involved in delivering orders over a network, and orders can theoretically be sent and received at any point during a trading interval, the present invention provides a framework of rules that help to establish which orders will qualify for an auction. (It is understood that any of the rules described herein may, in some cases, vary or be altered by agreement without departing from the scope of this invention.) This framework of rules is implemented by time analysis system 41.

The first rule involves a time period t1, which is chosen by market maker 12 and referred to herein as a trade cut-off time. The trade cut-off time t1, which is less than t0, is the duration after T(i−1), during which orders can reach a point in the network (e.g., node 20) where an agent of market maker 12 (usually a trusted computer) can time stamp the order. Thus, setting t2=t0−t1, it can be seen that T(i)−t2 is the time by which an order has to reach a time stamping agent to qualify for the pricing and trade at time T(i). This point on the time line 54 is shown as T′(i).

A second rule states that in order to participate to the pricing at T(i), the order also has to reach market maker 12 by T(i), which is the endpoint of the trading interval. This rule is further refined by the fact that for orders being processed at T(i), there is a very short machine processing time Δ. Accordingly, each such order has to be in the trading system 40 of market maker 12 by T(i)−Δ(i.e., the effective endpoint) to be considered as arriving on time. While t0 is expected to be of the order of a few minutes, and t2 of the order of a few seconds, present time technology allows Δ to be of the order of a small fraction of a second. Furthermore, t2 should be enough time so that, except for serious disruptions in the traffic of the network, any order time stamped by T′(i) can reach the trading system of market maker 12 by the effective endpoint T(i)−Δ. The time T(i)−t2 (i.e., T′(i)) is the primary time a trader should therefore be concerned with. Thus, in operation, market maker 12 broadcasts a price P(S0, T(i−1)) and a time T′(i) (or the time remaining to T′(i), which becomes negative after T′(i)) until the next price fix at T(i). As orders are received back at market maker 12, time analysis system 41 checks each order to see if the order qualifies for processing at T(i).

Note that it is well understood in the art how to closely synchronize clocks of distributed entities, including software synchronization of clocks and hardware assisted synchronization of clocks such as through reception of satellite based Global Positioning System (GPS) clock signals. These approaches may be used to keep the clocks of market maker 12 and of all the trusted gateway agent systems of market maker 12 synchronized.

As an alternative embodiment, market maker 12 may be a collection of machines, distributed throughout the network rather than a centralized server. Distributed servers implementing market maker 12 may each collect bids for orders, and may vote collectively on prices of each issue at time T(i). Note that this approach will improve scalability and reduce time t2, while possibly increasing Δ such that T(i)−Δ is closer to T′(i).

Given that customers around the world can receive a broadcast price P(S0,T(i−1)), as well a location where S0 is traded, any customer having access to a machine or human terminal can participate in the trading at time T(i). We notice that, even with the traffic reduction provided by the present invention, sending quotes on a variety of securities to a large pool of traders interested in different sets of securities is not completely trivial. However, present time so called Publish and Subscribe (Pub/Sub) technologies provided by several companies such as IBM or TIBCO™ are sufficient to accommodate this type of reduced demand, even to millions of customers.

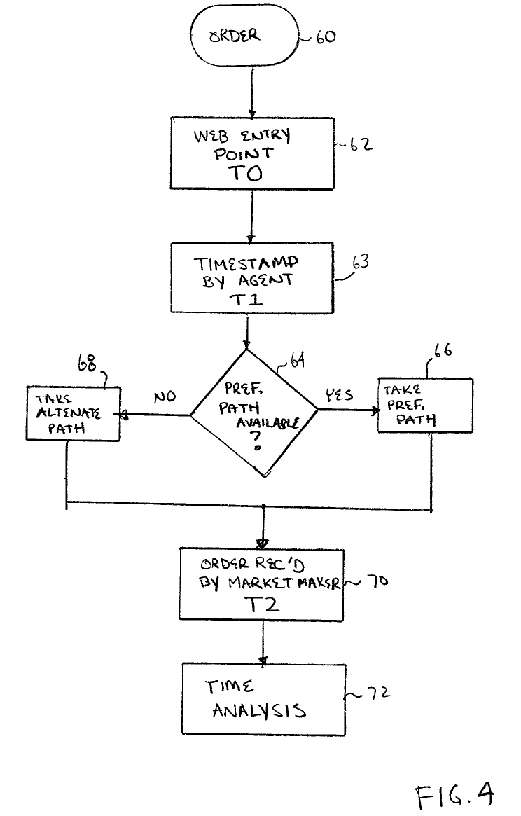

Details of how an order may be processed is described with reference to FIGS. 4-6. Referring first to FIG. 4, a customer composes an order 60 and submits it via a web entry point 62 (or some other communication network) using a computer or other device linked to the network. As discussed, for an auction at T(i), the order should be submitted at a time prior to T′(i).

At a first trusted gateway 32, the order is time stamped 63 at time T1. Since money and possibly confidentiality are involved in the overall process, it is preferred that strong cryptography is used to make all processes private and secure. In particular, the time stamping should be non-counterfeitable and trusted by both market maker 12 and any regulatory authorities. For instance, the time stamping can use a digital signature based on the content of the order, a time stamping device number, a processing number at that device, and/or the time of stamping. Such technologies are well known and widely used. For the purposes of this example, it is assumed that the order is attached to its time stamp, so that the “order” can mean the combination of the order and accompanying time stamp.

If a preferred path for the order is available 64, then the order is directed along the preferred path 66. Otherwise an alternate path 68 may be utilized. The same Pub/Sub technology mentioned above to distribute quotes can be used to govern the routing of the orders as well. However, since the traffic for each transaction is expected to be lower than the overall information traffic along a path, a messaging middleware with guaranteed delivery as provided, for instance, by IBM in the MQ Series Integrator™ products may be used to carry the transactions. At time T2, the order reaches 70 the market maker trading system 40. The order is then submitted 72 to the time analysis system 41 to determine how to process the order.

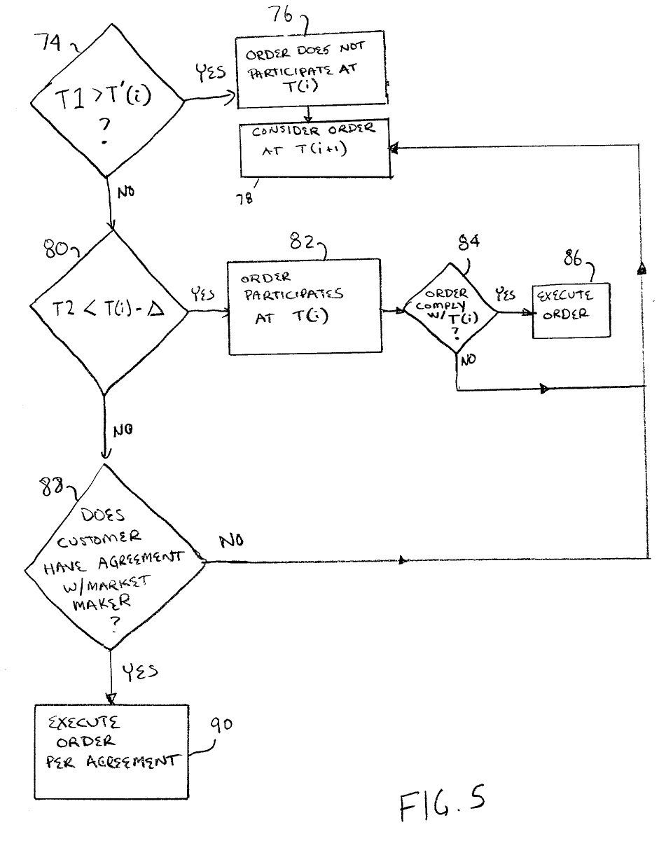

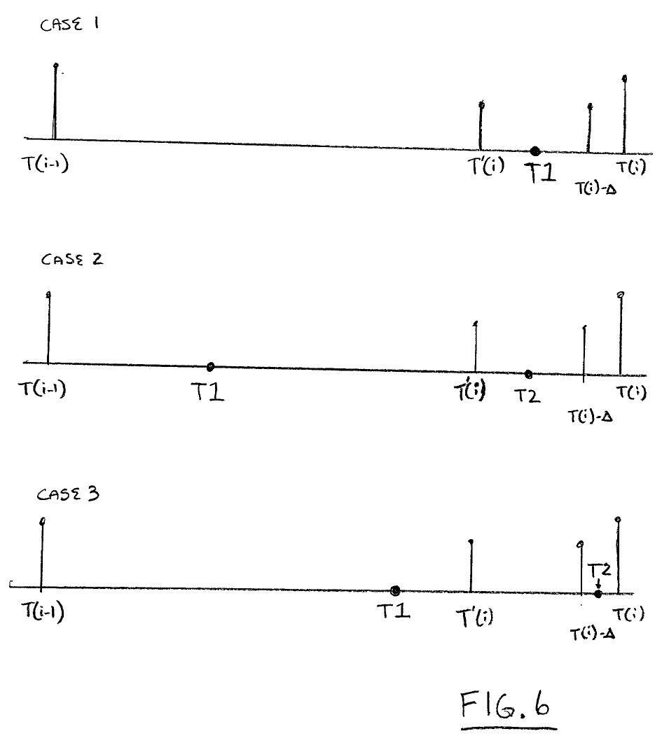

Referring now to FIG. 5, a flow chart depicting the functionality of the time analysis system 41 is shown. Generally, to determine if order qualifies for the auction at T(i), time T1 is compared 74 to time T′(i), and time T2 is compared 80 to T(i)−Δ. (Depending on the level of service provided to the customer, it is also possible that T2 may be compared with T(i).) First, if T1>T′(i), the order will not be considered for the pricing at T(i) 76. This example is shown as case 1 in the time line of FIG. 6. The order may be considered for pricing at T(i+1) 78 and put in the pool of orders to be considered at T(i+1) unless, for example, the order is of the “do by T(i) or cancel” type.

If T1<T′(i) and T2<T(i)−Δ, the order participates to pricing at T(i) 82. This example is shown as case 2 in the time line of FIG. 6. Next, the order is checked 84 to determine if it is compatible with the price fixed at T(i). If so, the order is executed 86. Otherwise, the order may be considered for pricing at T(i+1) 78 and put in the pool of orders to be considered at T(i+1) unless, for example, the order is of the “do by T(i) or cancel” type.

Finally, if T1<T′(i), but T2 is not less and T(i)−Δ, then time analysis system 41 would determine if the customer has an agreement 88 with the market maker 12 regarding this situation. This example is shown as case 3 in the time line of FIG. 6. If there is no agreement, the order may be considered for pricing at T(i+1) 78 and put in the pool of orders to be considered at T(i+1) unless, for example, the order is of the “do by T(i) or cancel” type.

Otherwise 90, depending on the rules and the type of network services contracted by the customer, the order can still be executed at T(i). It may also be executed at a later time at the pricing established at T(i) if this has been agreed upon, or even at the best price between T(i) and the time of execution if such service is provided, possibly for an extra fee. Alternatively, the order may be entered in the pool for the next possible time of pricing, except for example, if the order carries a limit on time which cannot be respected because of latencies on the network and lack of compensating protocol, in which case it is canceled.

Internet Service Providers (ISPs) may offer several forms of contracts to the customers. For instance, for the cheaper price, the customer would take the risk that his/her order does not arrive to the market maker by T(i), while for the higher price, the provider would guarantee either P(S0,T(i+1)) or the best of the prices P(S0, T(i)), P(S0, T(i+1)), . . . , P(S0, T(i+n)), where P(S0, T(i+n)) is the time by which the order reaches the market maker whenever the order is time stamped by T(i)−t2.

The mechanisms proposed here to allow for scalability and fairness for trades offered on a Wide Area Network (WAN) can also be used to help scale up the number of trades that can be fairly handled on a Local Area Network (LAN). In both the cases of WAN and LAN, progresses in technology may eventually allow time t0 to be reduced so that for all practical purposes, the customer cannot see the difference with a continuous trading system.

A further step toward fairness may be taken to allow all customers to have, on average, similar access or time of knowledge to P(S0,T(i−1)). To that effect, the broadcast of information at T(i−1) on the network can be organized so that average latencies to reach remote locations are compensated by delayed diffusion to more easily reach each customer. This can be achieved for instance by encrypting the quote using different keys so that the keys that can be decrypted in closer locations are used to send quotes with the appropriate delay.

It is understood that the present invention can be realized in hardware, software, or a combination of hardware and software. The components as described herein can be realized in a centralized fashion in a single computerized workstation, or in a distributed fashion where different elements are spread across several interconnected computer systems (e.g., a network). Any kind of computer system—or other apparatus adapted for carrying out the methods described herein—is suited. A typical combination of hardware and software could be a general purpose computer system with a computer program that, when loaded and executed, carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, module, mechanism or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for implementing an electronic marketplace via a network, comprising:
a market maker that receives orders for a series of call auctions from a plurality of nodes in the network, wherein each of the orders includes a time stamp from one of a plurality of agents residing within the network, and wherein each call auction is implemented at an end of a trading interval;
a trading system that sets prices and processes orders for each call auction; and
a time analysis system that examines each order submitted during a current trading interval to determine if the submitted order qualifies for the call auction at the end of the current trading interval.

2. The system of claim 1, wherein each trading interval includes a fixed amount of time.

3. The system of claim 1, wherein each trading interval includes a variable amount of time defined by the trading system.

4. The system of claim 1, wherein the trading system defines a trading cut-off time during each trading interval.

5. The system of claim 4, wherein the time analysis system qualifies orders by comparing the time stamp for each order with the trading cut-off time for the current trading interval.

6. The system of claim 5, wherein the trading system defines an effective endpoint for each trading interval based on a computational time of the market maker.

7. The system of claim 6, wherein the time analysis system further qualifies orders by comparing a time the order was received by the market maker with the effective endpoint of the current trading interval.

8. The system of claim 1, wherein the trading system executes each order that qualifies for processing at the call auction of the current trading interval unless an order price does not meet a price fixed by the trading system.

9. The system of claim 8, wherein the trading system places each order that does not qualify for processing into a queue for consideration during a subsequent call auction.

10. The system of claim 1, further comprising a system for broadcasting price quotes to each of the nodes in the network.

11. A program product stored on a recordable medium for implementing an electronic marketplace via a network, comprising:
means for receiving orders for a series of call auctions via a plurality of nodes in the network, wherein each of the orders includes a time stamp from one of a plurality of agents residing within the network, and wherein each call auction is implemented at an end of a trading interval;
means for setting prices and processing orders for each call auction; and
means for examining timing information for each order submitted during a current trading interval to determine if the submitted order qualifies for the call auction at the end of the current trading interval.

12. The program product of claim 11, wherein the means for examining timing information compares the time stamp for each order with a predetermined time set during the current interval to determine if the order qualifies for processing.

13. The program product of claim 12, wherein the means for examining timing information compares a time the order was received with an effective endpoint set during the current interval to determine if the order qualifies for processing.

14. The program product of claim 11, further comprising means for broadcasting prices over the network.

15. An electronic exchange implemented over a network that processes a series of call auctions, each call auction occurring at an end of a trading interval, comprising:
a plurality of network nodes that communicate market information, wherein the market information includes orders submitted from market participants;
a plurality of gateway agents that timestamp orders after they are submitted by the market participants to the network; and
a market maker system that receives and executes orders over the network, wherein the market maker system determines if each order qualifies for the call auction at the end of a current trading interval by examining the timestamp for the order.

16. The electronic exchange of claim 15, wherein the market participants submit orders to the network from user interfaces that communicate with the network nodes.

17. The electronic exchange of claim 16, wherein the user interfaces comprise web browsers.

18. The electronic exchange of claim 16, wherein the user interfaces comprise cellular devices.

19. The electronic exchange of claim 15, wherein the market information further includes quote information established at a previous call auction.

20. The electronic exchange of claim 19, further comprising means for ensuring that all network nodes receive quote information within a predetermined window of time.

21. The electronic exchange of claim 20, wherein the quote information is distributed over the network using a Pub/Sub technology.

22. The electronic exchange of claim 15, wherein gateway agents obtain times for the time stamps from a global positioning system.

23. The electronic exchange of claim 15, wherein the market maker qualifies each order if the timestamp for the order is less than a predetermined time set during the current trading interval.

24. The electronic exchange of claim 23, wherein the market maker further qualifies the order by comparing a time the order was received by the market maker with a second predetermined time set during the current trading interval.

25. A method of implementing an electronic exchange over a network, wherein the exchange executes a series of call auctions during sequential trading intervals, comprising the steps of:
broadcasting a price quote from a market maker over the network at a beginning of a current trading interval;
distributing the price quote over a plurality of network nodes within the network;
receiving an order submitted from a participant who is in communication with one of the network nodes;
time stamping the order when the order passes through a trusted node;
delivering the order to the market maker; and
examining the time stamp of the order to determine if the order qualifies for processing during the current trading interval.

26. The method of claim 25, wherein the price quote is distributed using a Pub/Sub technology.

27. The method of claim 25, wherein the order is submitted via a browser.

28. The method of claim 25, wherein the order is submitted via a cellular device.

29. The method of claim 25, wherein the time stamping obtains a time from a global positioning system.

30. The method of claim 25, wherein the examining step compares the time stamp to a predetermined time set during the current trading interval.

31. The method of claim 30, comprising the further step of comparing a time the order was received by the market maker with a second predetermined time set during the current trading interval.

32. The method of claim 31, comprising the further step of processing the order if it qualifies, wherein the processing step includes the steps of:
determining if an order meets a price set by the market maker at the end of the current trading interval; and
executing the order at the end of the current trading interval.

33. The method of claim 31, comprising the further step of considering the order for processing during a subsequent interval if the order does not qualify.

34. A method for implementing an electronic exchange over a network, wherein the electronic exchange executes a series of auctions at sequential time points, comprising the steps of:
broadcasting a price quote at a beginning of a trading interval;
receiving an order, wherein the order includes a timestamp received from a network agent;
comparing the timestamp with a first predetermined time set during the trading interval;
comparing a time the order was received with a second predetermined time set during the current trading interval; and
qualifying the order if both the timestamp is less than the first predetermined time and the time the order was received is less than the second predetermined time.
